(19) United States
(12) Patent Application Publication
(10) Pub. No.: US 2002/0014504 A1
(43) Pub. Date: Feb. 7, 2002

(54) Load-carrier with movable carriage for automotive vehicle

(76) Inventor: Ovila G. Hetu, Quebec (CA)

Correspondence Address: Richard A. Giangiorgi, TREXLER, BUSHNELL, GIANGIORGI,, BLACKSTONE & MARR, LTD., 105 W. Adams Street, 36th Floor, Chicago, IL, 60603-6299, US

(21) Appl. No.: 09/954,860

(22) Filed: Sep. 18, 2001

Related U.S. Application Data
(63) Continuation of application No. 09/586,219, filed on Jun. 2, 2000.

(30) Foreign Application Priority Data
Jun. 3, 1999 (CA) 2,274,331

(51) Int. Cl. B60R 9/042

(52) U.S. Cl. 224/310

(57) ABSTRACT

A load carrier for automobile vehicles comprising a frame adapted for attachment on top of a vehicle, said frame comprising a set of substantially parallel rails each having a front extremity and a rear extremity, a carriage comprising a set of longitudinal arms, each having a front extremity and a rear extremity, said carriage being slidingly mounted to said rails to allow axial movement of said carriage along said rails, said carriage being movable between a transport position, wherein said carriage is placed on said frame in a substantially stable position and a loading/unloading position, in which said carnage is moved rearwardly and pivoted downwardly with respect to said frame and the front extremity of the longitudinal arms of the carriage is spaced apart rearwardly from said rear extremity of the rails.

### FIELD OF THE INVENTION

The invention relates to a load carrier for automobile vehicles, and more particularly to a load carrier provided with a movable carrier to make the loading/unloading operations easier.

### BACKGROUND OF THE INVENTION

Load carriers for vehicles are well known. Traditionally, a load carrier comprises a surface adapted to receive a load, and means to mount the device on top of a vehicle. The user who wants to install a load or remove it, simply lifts it up, and places it on the carrier, or lifts it up to remove it and places it on the ground. This operation may be easy for light objects, provided the user is healthy and the vehicle is small.

But if the load is heavy or bulky, or the user is unhealthy, or the vehicle top is high, this operation may become difficult or even hazardous.

Extendable auto racks are also known. For instance, U.S. Pat. No. 3,193,124 describes an extendable auto rack for boats. A load carrying frame is slidingly and pivotally mounted to a mounting frame. When the load carrying frame is moved backwards, the front rollers allow to pivot downwards the rear portion of the carrying frame. Such a configuration has, however, some limitations. For example, when used with a minivan or station wagon type vehicle or the like provided with a rear door opening upwardly; the length of the mounting frame or rails is limited at the rear of the vehicle in order not to interfere with the opening of the rear door. With short length rails, the carrying frame may hit the back of the vehicle when pivoted downwardly. This may cause damages to tho vehicle body or to the rear window.

Considering the increasing number of high vehicle such as 4×4 vehicles or minivans, there is a strong demand for an improved lead carrier of an easier and safer use.

### OBJECTS AND STATEMENT OF THE INVENTION

It is thus an object of the invention to provide a load carrier easy to load and/or unload.

It is another object of the invention to provide a light weight load carrier of a simple and reliable construction.

It is another object of the invention to provide a load carrier better suited to vehicles such as 4×4 vehicles or minivans.

As embodied and broadly described herein, the invention provides a load carrier for automotive vehicles comprising a frame adapted for attachment on top of a vehicle, said frame comprising a set of substantially parallel rails, each having a front extremity and a rear extremity, a carriage comprising a set of longitudinal arms, each having a front extremity and a rear extremity, said carriage being slidingly mounted to said rails to allow axial movement of said carriage along said rails, said carriage being movable between a transport position wherein said carriage is placed on said frame in a substantially stable position and a loading/unloading position in which said carriage is moved rearwardly and pivoted downwardly with respect to said frame and the front extremity of the longitudinal arms of the carriage is spaced apart rearwardly from said rear extremity of the rails.

As the mobile carriage can translate and pivot, it allows an easy manipulation. The carriage may be placed on the top of the vehicle very easily. The carriage may also be lowered simply by moving it rearwards and pivoting it downwardly. This provides easy access even if the top of the vehicle is high. The user does not have to lift the entire weight of the load, since one side or one end of the carriage can remain attached to the frame. Moreover, the construction enables the carriage to move/pivot rearwards/downwards such as to become spaced apart from the rear of the vehicle. This resulting space provides safety and avoids that any damage is caused to the vehicle itself or to any accessory thereof.

The transportation position provides full safety. The carriage may be secured to the frame or directly to the roof of the vehicle. The second position (loading/unloading) spares the user lifting heavy loads with his arms. The loading/unloading operations are very easy to achieve, even if the user is not healthy.

Advantageously, the load carrier comprises a pivoting and spacing member having a spacing arm pivotally connected at a first extremity to the longitudinal arm and at a second extremity, pivotally connectable to said frame.

This is a very simple, reliable and economical way to design the load carrier of the invention and to provide the required space between the carriage and the rear of the vehicle.

Advantageously the pivoting and spacing member comprises a retractable connecting member having a first end connected to said longitudinal arm and a second end connected to the spacing arm, so that said carriage, when in said loading/unloading position, can not pivot downwardly more than a given angle with respect to said spacing arm. The angle may depend on the connecting member maximum extended length, its configuration and its position with respect to said spacing arm and longitudinal arm.

Moreover, the downward pivoting path of the carriage may be limited so that the pivoting assembly should not be lowered more than a given angle. This may be achieved with a pivot member whose angular path is limited. Such a feature may provide a more convenient loading/unloading position or it may contribute to increase the gap between the carriage and the vehicle.

The load carrier of the invention preferably comprises a pivoting and spacing member connected to each longitudinal arm.

The load carrier advantageously comprises a front sliding member and a rear sliding member provided on said carrier and adapted to slide axially with respect to said rails, said rear sliding member being disengageable from the rails and said front sliding member being also adapted to pivot angularly with respect to said rails when said rear sliding member is disengaged from said rails.

The load carrier advantageously comprises a front stopper member disposed in a first end portion of the rails and/or a rear stopper member to limit the sliding movement at the rear portion of the frame. It may also comprise a locking member of known type adapted to secure the carriage to the frame and/or to the roof of the vehicle when in the transport position.

Other objects and features of the invention will become apparent by reference to the following description and drawings.

### BRIEF DESCRIPTION OF THE DRAWINGS

A detailed description of the preferred embodiments of the present invention is provided hereinbelow, by way of example only, with reference to the accompanying drawings, in which:

FIG. 1 is a side elevational view illustrating the load carrier according to the invention, installed on top of a vehicle and in the transport position;

FIG. 2 is a side elevational view illustrating the load carrier according to the invention, installed on top of a vehicle and in the loading/unloading position;

FIG. 3 is an enlarged view of the load carrier shown in FIG. 2;

FIG. 4 is a perspective view of the load carrier according to the invention;

FIG. 5 is a further perspective view of the load carrier according to the invention with the carrier substantially mid-way between the transport and the loading/unloading positions;

FIG. 6 is an enlarged perspective view of the load carrier according to the invention in the loading/unloading position;

FIGS. 7 and 8 illustrate variants of the pivoting and spacing member.

In the drawings, preferred embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF PREFERRED EMBODIMENTS

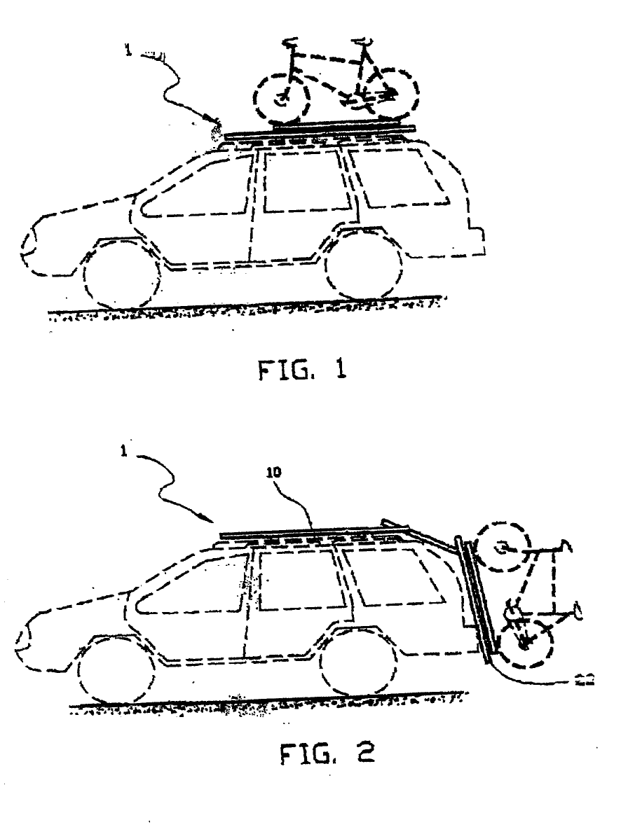

FIGS. 1 to 3 illustrate the operation of the load carrier according to the invention. When the user wishes to put an object on the carrier or take it out of it, the carriage of the load carrier is easily displaced from the central portion of the top of the vehicle, where the access is limited due to the height and the width of the vehicle.

The rails 12 and 14 allow a longitudinal or lateral displacement of the carriage 20. Once the latter is off the vehicle body, pivoting and spacing members 30 allow to lower at least one end of the carriage near to the ground surface for example.

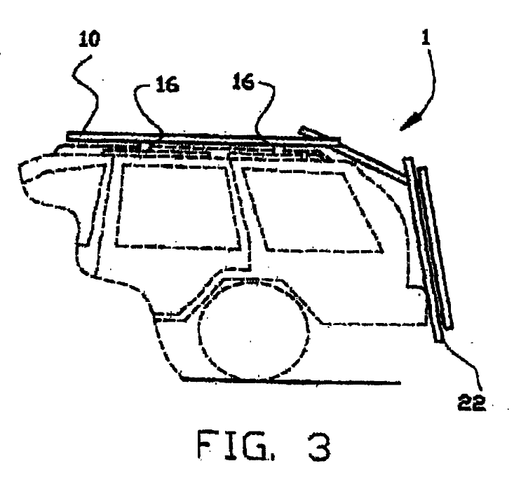

In FIG. 1, the load carrier 1 of the invention is shown installed on top of a motor vehicle. The carriage is in the transport position. In FIGS. 2 and 8 the carriage is displaced off the vehicle body, in a pivoted position. From this position, it is of an easy access. It can also be taken out of its rails to be entirely laid down on the ground.

In another embodiment (not shown), in which the rails are disposed transversally with respect to the vehicle, the load is placed or removed from the vehicle by pulling the carriage sidewards.

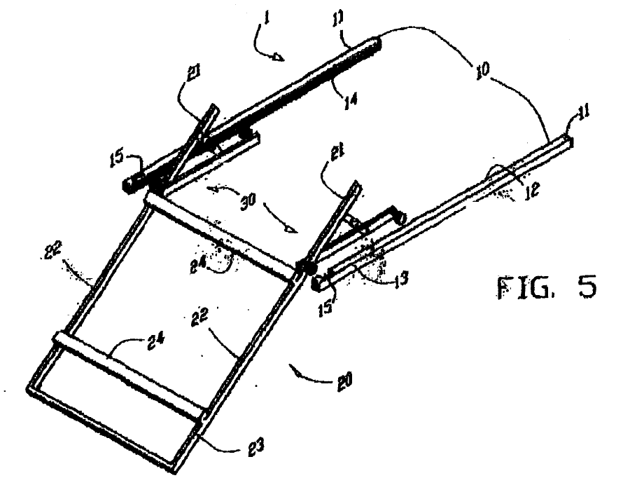

FIG. 4 illustrates a first embodiment of the load carrier assembly 1 from the top. In this embodiment, the frame 10 comprises two rails 12 and 14 that are adapted to fit to the top of the vehicle, for instance in a longitudinal position. In this example, the rails are connected to bridging members 16, of known type, removably secured in a traditional way on top of the vehicle. In the description, the expression frontal portion or frontal member or the like is used to designate an element adapted to be placed near or towards the front of the vehicle; the expression rear portion, rear member or the like is use to designate an element adapted to be placed near or towards the rear of the vehicle.

FIG. 4 illustrates an embodiment with two bridging members 16, other arrangements are also possible. The attachment to the vehicle is possible by using attachment points or the longitudinal bars provided on the top of most recent vehicles, or more traditionally, by using the top side rails generally used to protect the vehicle sides from rain and water. The frame 10 could also be provided without any bridging members. In such a case, the frame would be attached to connecting bars already installed on top of the vehicle.

The load carrier also comprises a mobile carriage 20, adapted to translate and pivot along the rail 12 and 14. In the embodiment illustrated in FIG. 4, the carriage comprises two longitudinal arms 22 extending longitudinally and maintained spaced apart from one another by bridge members 24, extending transversally and connected to each arm 22, to form for instance a rectangular configuration. The shape, number and arrangement of the bridge members 24 could be modified without departing from the spirit of the invention.

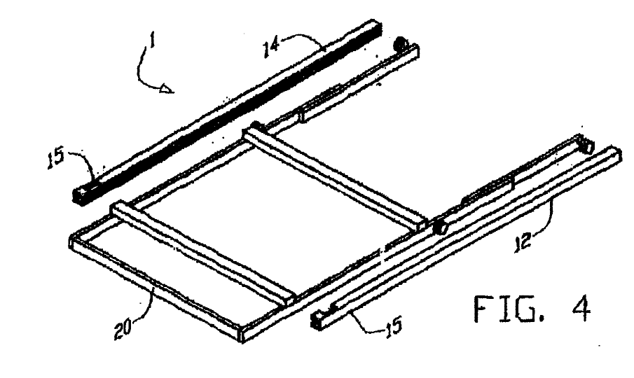

As shown in FIGS. 2 and 3, the dimensions of the frame, and more particularly of the rails, are preferably established to allow the rear portion of the rails to come as far as possible to the rear of the vehicle. However, the rails do preferably not extend beyond the top of the vehicle, in order not to interfere with the opening of the rear door of the vehicle. In fact, such a door, when being pivoted upwardly, could hit the rails if they extend long enough beyond the rear of the vehicle. It would thus not be possible to open the door completely. Loading or unloading the vehicle would thus become very difficult or at least uncomfortable.

The length of the rails must thus be appropriate. This is made easy by providing adjustment possibilities in the longitudinal position of the rails during the load carrier installation.

The rails as well as all the main components of the load carrier may be made of any material that is adapted to support the weight of the load installed an top of the carrier, in addition to the constraints due to the speed and bad road conditions. Steel, aluminum, composite, etc, are only few examples.

The rail profile may take various shape. The illustrated rails are provided with a C-like profiles. The inner portion of the profile is thus advantageously used to adapt one or more sliding members 28/25, such as ball bearings, rollers, sliders, etc. These sliding members are connected to the carriage, so that the carriage may translate forwards and backwards along the rails. The illustrated example is provided with two sets of sliding members: front sliding members 28 and rear sliding member 25. This configuration is given only as a purpose of illustration. Other configurations am also possible without departing from the spirit and scope of the invention.

In the illustrated example, because the rails are of close type, the rear portion is provided with an opening 15. The dimensions of the opening allow the user to pull out the rear sliding member 25. FIGS. 4 to 6 clearly illustrate the two openings of this example. When the rear sliding members 25 are removed from the rails 12 and 14, the user may easily pivot the carriage upwardly or downwardly if the rear sliding members are behind the end of the rails. Otherwise, with the present embodiment, they would interfere with the rails.

According to the invention, the lead carrier is provided with a pivoting and spacing member 30 to allow the carriage to be placed spaced apart with respect to the back of the vehicle when pivoted downwardly. FIGS. 4 to 6 illustrate an example of such pivoting and spacing member 30.

In the illustrated example, the pivoting and spacing member is provided on the carriage. In a variant (not shown), it could also be provided on the frame. Each longitudinal arm 22 front portion is provided with a spacing arm 31, pivotally connected to the longitudinal arm 22. The spacing arms are in the same longitudinal as the longitudinal arms 22 with a transversal pivoting axis. The spacing arms 31 are preferably arranged to pivot downwardly with respect to the carriage 20. As seen in the figures, this causes the arm rear extremities 23 of the carriage to pivot downwardly and the arm front extremities 21 to pivot upwardly. When the load carrier is in a normal operating condition, on top of a vehicle and on an substantially horizontal surface.

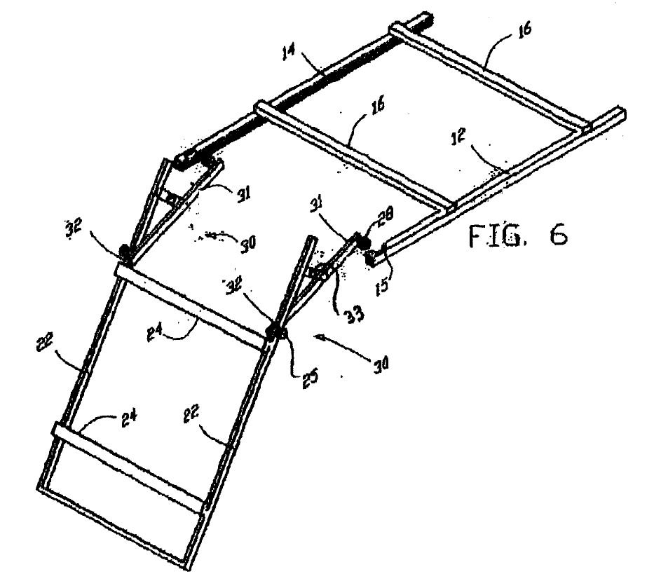

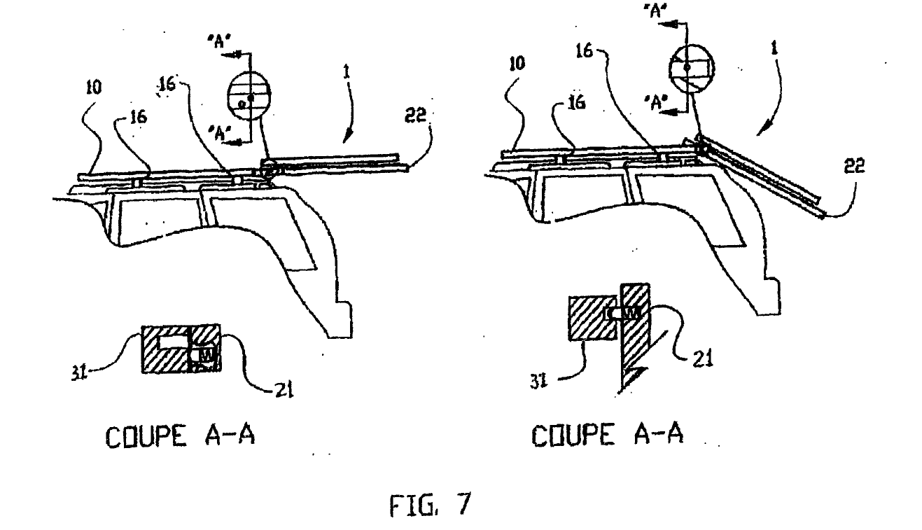

The pivoting angle of the longitudinal arms 22 is preferably limited with respect to the spacing arms 31. In the illustrated example, an extendable connecting member 33 is up to provide this limitation. It could be an extendable rod assembly as shown in FIGS. 5 and 6, a piston, etc. FIG. 5 shows one end of a rod assembly pivotally connected to the longitudinal arm front extremity 21 and another end to the spacing arm 31. As soon as the longitudinal end 22 reaches a given angle, the connecting member 33 reaches its maximum extension position, avoiding any additional angular movement of the arms 22.

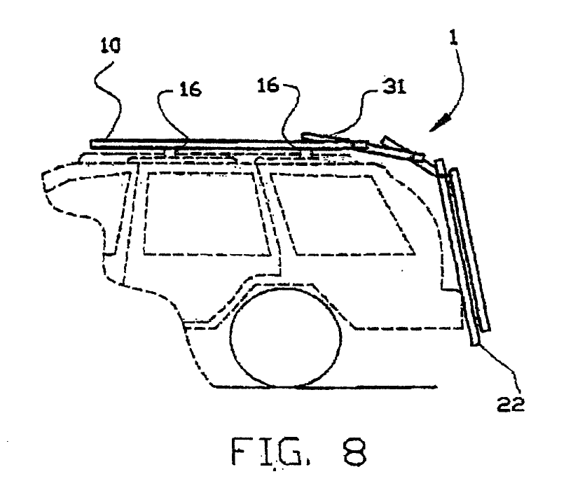

FIG. 7 illustrates and/or example to limit the angular movement of the longitudinal arms 22 with respect to the spacing arms 31, provided with a known-type retractable ball arrangement.

FIG. 8 illustrates another example of pivoting and spacing member 30 provided with a multiple spacing arms arrangement.

The load carrier of the invention operates as follows:

In the transportation mode or position, the carriage is normally in the most forward position. The front extremities 21 of the longitudinal arms 22 cooperate with the front stoppers (not shown). The locking members are in the locked position. The carriage is thus well secured and can not move forwards, backwards or vertically. This is very important for safety reasons, namely when the vehicle moves.

To load or unload the load carrier, when the vehicle is stopped, the locking members are put in the free position. The carriage can thus translate rearwards. Optional handles (not shown) may help for this operation.

First, the carriage is pulled rearwards until the rear sliding member 25 reach the stopper, located for example behind the openings 15 of the rails. Once the carriage is in this position, the rear sliding members 25 may be pulled out from the rails through openings 15. The carriage may thus be farther pulled rearwardly until the front sliding members 28 reach the stopper.

The carriage is thus free to be pivoted downwardly either until it reaches a support, such as the ground or a portion of the vehicle on which the carriage may rest, etc. FIG. 3 illustrates an example where the carriage rests on the rear bumper of the vehicle.

The pivoting and spacing member 30 secures the rear portion of the vehicle and ensures that the carriage remains spaced apart from the latter, at least enough to avoid any unintentional contact between the carriage and the vehicle.

The loading/unloading operations are thus considerably easier to perform. If desired, the carriage may be totally removed from the frame and put on the ground or a stand.

The opposite steps are required to put the carrier back onto the top of the vehicle.

The load carrier illustrated advantageously further comprises at least one locking member (not shown). This member is used to secure the carriage during transportation. For instance, the locking member may comprise an elongate pin or rod, movable between a first free position, and a second locked position. In the locked position, the pin is inserted into corresponding locking apertures provided co-axially to the pin in the rear extremity region of the rails. This secures the carriage to the frame. In the free position, the pin is extracted from the aperture. Other locking arrangements are also possible.

The load carrier illustrated also preferably comprises stoppers provided at the rail front extremities 11 and the rail rear extremities 13. The stoppers prevent the carriage from travelling too far in the forward and/or rearward directions.

The carriage 20 advantageously comprises at least one handle, provided in the rear portion of the carriage. The carriage handling is thus made easier and more convenient.

Several modifications to the described embodiment are possible. For instance, the carriage is shown with bridging members 24. These members could be used to support any type of support or loading device, for instance a container, a ski rack, a bicycle rack, a luggage rack, etc.

The members or elements 12, 14, 16, 22, 24 are shown with hollow square profiles. These shapes could be modified without departing from the spirit and scope of the invention. The materials used for these elements are advantageously selected to be as light as possible and to offer good strength and stiffness properties. Examples of such materials are aluminum, steel, composite, etc.

The above description of preferred embodiments should not be interpreted in a limiting manner since other variations, modifications and refinements are possible within the spirit and scope of the present invention. For instance, the carriage described in the different embodiments may be completed or replaced with any other type of device allowing to transport a given load, such as a container, a ski rack, a bicycle rack, etc.

The scope of the invention is defined in the appended claims and their equivalents.

The embodiments of the invention for which an exclusive privilege or property is claimed are defined as follows:

1. A load carrier for automobile vehicles comprising a frame adapted for attachment on top of a vehicle, said frame comprising a set of substantially parallel rails each having a front extremity and a rear extremity, a carriage comprising a set of longitudinal arms each having a front extremity and a rear extremity, said carriage being slidingly mounted to said rails to allow axial movement of said carriage along said rails, said carriage being movable between a transport position wherein said carriage is placed on said frame in a substantially stable position and a loading/unloading position in which said carriage is moved rearwardly and pivoted downwardly with respect to said frame and the front extremity of the longitudinal arms of the carriage is spaced apart rearwardly from said rear extremity of the rails.

2. A load carrier as defined in claim 1, comprising a pivoting and spacing member having a spacing arm pivotally connected at a first extremity to the longitudinal arm and at a second extremity, pivotally connectable to said frame.

3. A load carrier as defined in claim 2, wherein said pivoting and spacing member comprises a retractable connecting member having a first end connected to said longitudinal arm and a second end connected to the spacing arm, so that said carriage when in said loading/unloading position, can not pivot downwardly more than a given angle with respect to said spacing arm.

4. A load carrier as defined in claim 3, wherein said angle depends on the connecting member maximum extended length, its configuration and position with respect to said spacing arm and longitudinal arm.

5. A load carrier as defined in any one of claims 1 to 4, comprising a pivoting and spacing member connected to each longitudinal arm.

6. A load carrier as defined in any one of preceding claims, comprising a front sliding member and a rear sliding member provided on said carrier and adapted to slide axially with respect to said rails, said rear sliding member being disengageable from the rails and said front sliding member being also adapted to pivot angularly with respect to said rails when said rear sliding member is disengaged from said rails.
